(19) United States
(12) Patent Application Publication
(10) Pub. No.: US 2022/0383007 A1
(43) Pub. Date: Dec. 1, 2022

(54) METHOD OF CAPTURING, CLONING, CRACKING, AND BRUTE-FORCING RFID ACCESS BADGES

(71) Applicant: Raxis, LLC, Atlanta, GA (US)

(72) Inventor: Phillip Bosco, Cedar Park, TX (US)

(21) Appl. No.: 17/752,989

(22) Filed: May 25, 2022

Related U.S. Application Data
(60) Provisional application No. 63/192,782, filed on May 25, 2021.

(51) Int. Cl. G06K 7/10; G06K 19/07

(52) U.S. Cl. CPC G06K 7/10366; G06K 19/0723

(57) ABSTRACT

A method of capturing, cloning, cracking, and brute-forcing RFID access badges, comprising a first device configured to identify and capture a first badge automatically, and identify and capture a subsequent badge automatically, the first device configured to automatically recognize badges in a vicinity. Using at least one computer processor or logic machine, the method includes sending badge information to at least one of a mobile app and a second device. The second device may be configured to immediately begin a simulation process of a successfully captured badge.

### FIELD OF THE INVENTION

The present disclosure is generally related to access badges and more particularly to a method of capturing, cloning, cracking, and brute-forcing RFID access badges.

### BACKGROUND OF THE INVENTION

It is common for establishments or individuals to secure an area or item from unauthorized access. For example, a business owner typically locks the exterior doors of a brick & mortar business when closing up shop for the night. As another example, a sensitive or high-valued object could be secured in a locked room via a locked door.

Locks can take various forms, but more recently digital locks have become the standard because of the ability to control the unlocking capability of keycards and RFID badges with great granularity, convenience, and flexibility. For example, at any moment, a keycard's unlocking capabilities can be controlled for a specific set of doors among various doors in an establishment. Such digital systems typically use various encryptions and cryptographic keys to control such access and can rely on a closed private network or in some instances wireless or internet communicators to enable this control.

A penetration tester (also known as a pentester or ethical hacker) is an individual or entity that is hired to test and evaluate the security of a system. For example, a pentester could identify weaknesses and the possible access of unauthorized parties. The UK National Cyber Security Center describes penetration testing as: “A method for gaining assurance in the security of an IT system by attempting to breach some or all of that system's security, using the same tools and techniques as an adversary might.”

However, there is a problem that penetration testers face. Currently there is no way to conveniently test vulnerabilities of an RFID access badge using cracking or brute-force attacks, especially when conducted at long ranges.

Therefore, there exists a need in the art for a method and/or system that allows pentesters to effectively determine, in the real-world, if an RFID badge crack or brute-force attack is a potential vulnerability for a system. Even further, pentesters would like to discover this risk for their clients using a wireless, long range, and non-contact method that could be executed secretly.

### SUMMARY OF THE INVENTION

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Disclosed is a method of streamlining a process of capturing, cloning, cracking, and brute-forcing RFID access badges, at both short and long ranges.

In one example (non-limiting) embodiment the method provides a way to effectively demonstrate real-world security risks affecting organizations across the globe.

In another example embodiment, an RFID antenna is included, inside a standard laptop messenger bag, where the RFID antenna could be battery powered, operating over a wireless communication technology via a mobile app.

As yet another non-limiting embodiment, the RFID antenna could include a High-Frequency and Low-Frequency antenna, where the RFID antenna could operate at a 6-4 ft distance, where such distance is any appropriate distance to capture, clone, simulate, brute-force, crack, etc. nearly every type of RFID access badge.

In another aspect, the disclosed system is considered an “all-in-one” RFID device which eliminates the necessity of combining or integrating several discrete systems to achieve the abilities and functions described herein.

In another aspect, the disclosed system is an all-in-one RFID device that combines the ability for the communication between various parts of the disclosed system via HID MaxiProx 5375 and reading Proxcard II type badges, where both of these technologies could be usable simultaneously, where concurrently, the disclosed system simulates and brute-forces the system in situations where badges are read or interacted with.

In another aspect, the disclosed system allows for long-range reading and various other functions as detailed herein, where these functions could relate to either or both LF and HF frequencies, all via one unit of this herein disclosed system.

In another aspect, the disclosed system allows for penetration testing and security assessment by demonstrating existing vulnerabilities in technologies, wherein through the provided examples herein, the disclosed system is configured to allow a skilled technician to identify areas of a security system that are lacking protection in a streamlined and effective way, such that the disclosed features and functions can be provided without the need for carrying various gear, inconveniently typing lines of code or commands, and the need to use an inconvenient plurality of terminal prompts to demonstrate vulnerabilities, and wherein the disclosed methods and/or systems provide a streamlined way to discover flaws in a particular RFID access control system.

In another aspect, the disclosed system could be used as reader replacements for various types of organizations, wherein for pentesters, the system provides a useful ability to crack and/or clone RFID access control badges in unique ways, and wherein using Proxmark3 open-source hardware and firmware, it is possible to use the system without needing two separate antennas, and without needing to type the above mentioned extra commands, and wherein instead, the disclosed unique system improves upon this issue and removes such restrictions, allowing a pentester to walk into a client's site, walk past target people, and/or stand next to a target person in the elevator, while concurrently capturing and cloning their badges from several feet away, and further allowing access into a building using that target person's identity.

In another aspect, the disclosed system allows the pentester to demonstrate massive vulnerabilities in access control systems that are infiltrated using the disclosed system, where the term “pentester” could be used herein for defining an individual that uses the system to, for example, crack, sidestep, or otherwise bypass the encryption of a target badge.

In another aspect, the user could be an information security consultant, security auditor, a cybersecurity penetration tester, or any professional paid to test security systems of companies.

In another aspect, the disclosed system can be used to demonstrate, in real time, the cracking of MIFARE CLASSIC badges without typing any complicated commands while assisted by an elegant mobile application to completely automate the typically multi-step cracking operation process.

In another aspect, a core part of the operation of the disclosed system is a Proxmark3 open-source firmware and custom modified hardware to run the Proxmark3 source code, wherein a specially configured long-range antenna interfaces directly with a Proxmark3 backend code, wherein a mobile app could be configured to be responsible for sending commands while receiving data to make decisions and write, emulate, brute-force, store history, etc. of all badges captured or used during an assessment, and wherein a mobile app could be a custom defined set of automatically executing tasks responsive to user input.

In another aspect, the app could be automatically run by way of one or more computer processors, wherein mobile app could be custom made and the antenna hardware could also be custom made due to the unique set of abilities of the disclosed system, such that the majority of the disclosed system could be assembled into a volume similar to that occupied by a closed average laptop and such that the system could have antennas surrounding outside edges internally that allow the system to communicate with low-frequency and high-frequency access control badges of various technologies, and wherein, the device could have the dimensions approximately 12.0″×12.0″×1.0″ (30.5×30.5×2.54 cm).

In another aspect, the disclosed system allows full support of all technologies by leveraging Proxmark3 code and including specialized, custom designed LF and HF antennas, wherein the system has the ability to read, crack, and clone badges and expose areas of weak security, such that the disclosed system captures and clones a target access badge quickly and discreetly and could be used in various goals such as exposing security risks relating to access badges.

In another aspect, a dev kit could be included with highly customizable antennas, and furthermore, multifunction multiplexing interfaces could be supported, wherein an external battery, high-powered antenna, and Bluetooth interface could be included.

In another aspect, the system includes a unique and custom configuration of an LF and HF antenna, providing the various abilities described herein in addition to the ability to read badges, wherein such LF and HF antennas provide a proprietary dual-band LF/HF antenna arrangement that provides utility at long-range and the ability to identify, write, simulate, brute-force, and crack badges at such long ranges.

In another aspect, “long range” could be defined as having utility in any context described herein with at least 6 ft of distance between a target device and any of the disclosed systems, devices, antennas, or any wireless communicator subsystems, wherein the distance could be the distance between a “passport” device and a target device, as disclosed herein, or, the distance could be defined as a distance between “thor” and a target device.

In another aspect, identifying badges at long range could include scanning an entire LF and HF spectrum, identifying an unknown badge technology while allowing such identification to occur at distances far beyond a few inches (e.g. a plurality of feet), wherein using the current system, this step of identification could be done several feet away from a target device (i.e. long range) using “thor”.

In another aspect, writing badges at these long ranges could include writing data to a compatible badge, such as a T5577 badge, or the like, at long-range, and wherein simulating badges at long ranges could include using “thor” to digitally broadcast a badge signature from long-range, and wherein brute-forcing badges could include using “thor” to intelligently, automatically, effectively, and conveniently, simulate a badge ID while positioned near an RFID door reader (or the like) from long range.

In another aspect, such simulating a badge could occur in sequence a plurality of times to simulate badge IDs, one after the other, wherein this process could simulate a right combination of a valid badge ID and a door reader will unlock and provide access to a target area, and wherein cracking badges could include cracking an encrypted badge, vulnerabilities in such badges could be leveraged using “thor” to crack the badges at long distances, automatically.

In another aspect, the background processes could be done seamlessly for the user, without requiring prior experience in RFID technology, experience with specialized equipment, or typing code into a computer program.

In another aspect, the specialized antennas can provide the abilities mentioned herein by incorporating a specialized combination and pairing of custom-designed hardware and custom-software development.

In another aspect, using “thor”, a user can identify, crack, and capture a badge from several feet away, and once captured, this badge could be stored in a user's badge library, which could be encrypted, and which could reside in a mobile app, wherein from here a user could choose to simulate any supported badge type in their mobile app library of captured badges.

In another aspect, when simulating, either the “passport” or “thor” can provide simulation operations, wherein the “passport” is sleek and discreet and is perfect for security assessments, whereas Thor can simulate at long-distances, wherein if “passport” is simulating and the user is wearing it around their neck, they would bring the passport within range of the RFID reader on the wall to unlock doors and other areas that would normally require authorization using the target device.

In another aspect, a locked area that is accessible via a target device would become accessible using the “passport” and/or “thor” device, if “thor” is simulating at long range, the user may be able to simply walk right into locked doors, wherein due to the long-range simulation power of “thor”, it would be able to discretely and covertly trigger a door access reader as one would normally enable their passage through the doors.

In another aspect, the system includes a step-by-step process where the user chooses to simulate a badge from their library, automated through a mobile app, a user could set a mode to “automated” and choose to automatically simulate a most recently captured badge, providing utility to a user who has no idea what badge technology is being used at a target location, making the utility of the invention more universal.

In another aspect, while “thor” and “passport” are connected, a user could set the app to “automated mode” or Thor could jump to “identify mode”, where Thor scans for low and high frequency signals to identify the badges used by employees, where once close enough to a badge-wearing employee, Thor would automatically detect a badge type and thor would automatically switch to that badge technology type.

In another aspect, once “thor” switches, Thor would jump into capture mode for that badge technology that it has identified and capture a next badge it recognizes or sees, wherein if thor attempts to capture an encrypted technology, like MiFare Classic, Thor would then immediately jump into the appropriate phases of cracking the badge.

In another aspect, once completely captured and the cracking process is successful, the information will be sent from Thor to a mobile app stored in a library and then that information could be sent from the mobile app to the passport, Passport would immediately begin the simulation process of a successfully captured badge.

In another aspect, an automated scenario could include executing any of the above-mentioned steps in 3 seconds or less, as a non-limiting example, where this example 3 seconds could be three seconds starting from the time a badge is captured and ending at the time it is being simulated and ready for use by the passport. This mentioned 3 seconds could be accurate for many situations or embodiments but some embodiments could take longer. For example, in a LF/HF discovery scan, assuming a user is in range of a target badge with Thor, may take 5-40 seconds, depending on a few factors, badge type, etc. The cracking of a MIFARE Classic badge may also take about 30-45 seconds if the badge stays within range throughout the process.

In another aspect, as long as the devices are in some range, the system is able to execute any of the disclosed methods in a matter of 3 seconds or even less, where some badges would require cracking before being captured.

In another aspect, sending an alert includes notifying when a Passport is simulating a badge that is ready to use on a doorway.

In another aspect, the brute-force technology leverages a previously captured badge as an intelligent starting point, such that the user could use the disclosed suite of elements to brute-force a door given one or more previously captured badges having different access profiles.

In another aspect, the user could select which badge from their captured library to be a starting point for a brute-force operation, and whether they would like to use passport or thor for this process, and wherein the user could select “begin” on the mobile app to begin this process, and where the mobile app could instruct thor or passport to simulate one badge after the next until the door unlocks.

In another aspect, the processes could be done automatically at very rapid speed to brute force any suitable target system, wherein there could be code running in the background that makes the process as easy as selecting a starting point and selecting “go”.

In another aspect, a process flow for cracking could include, once a badge technology has been identified and is in range:

determining if the badge technology is one that requires cracking:

wherein the mobile app locates known and well-documented vulnerabilities for the encrypted card type and begins to execute an attack one after the other;

In another aspect, using the disclosed system, commands that typically are required for existing technologies such as MiFARE Classic are run automatically and dynamically based on the output received of the command that precedes it, wherein the process could be executed transparent to the user and the user would only know the badge technology was encrypted because the app notifies the user that the technology is/was an encrypted card type and that it was successfully cracked.

In another aspect, in a status update or notification, the user would see that Thor reports, “Please wait, cracking MiFARE Classic Badge. This should only take a few more seconds . . . ”, and once cracked, decrypted badge information could be sent to the mobile app for storage, where it can then be sent to Passport (or back to Thor) for brute-forcing, writing, or simulating.

In another aspect, various hardware described herein could be customized in special ways to run the Proxmark3 source code, where the specialized antennas can connect to or communicate with the Proxmark3 backend code, and wherein the specialized antennas could be located around and/or along one or more edges of the device.

In another aspect, with respect to Thor, a custom printed circuit board (PCB) could be used to run the Proxmark firmware, which also contains a Bluetooth low energy (BLE) chip, the BLE chip allowing communication with the mobile app, wherein a custom “shield” could be included for the hardware to perform on-device translation and decision-making capabilities elegantly within Thor itself.

In another aspect, Thor could be built from the ground up, specifically and specially for the purposes described herein, such that the PCB and shield could be custom designed such that Thor can be optimally and maximally leveraged and such that remote commands and captured data can be sent and received between the mobile app and thor.

In another aspect, the commands or data could be used in any appropriate way between the various elements, or sent to Passport for additional operations and functionality.

In another aspect, with respect to the Passport, this could be a neck-worn piece design to be portable, wireless, and completely discreet, wherein among others in this disclosure, this is a unique configuration at least due to its compact size and unique utility.

In another aspect, the Passport has no buttons, LEDs, switches, toggles, ports, or anything that would make the Passport appear to be something other than what it is imitating, wherein as a non-limiting example, if one were to inspect this device, they may be led to believe it is a light and small piece of plastic that would normally resemble an RFID badge holder that is commonly found.

In another aspect, the disclosed device resembles the badge in imitation of the visual appearance and/or weight of the badge and “resembling another device” is done for cosmetic and perception purposes because some of the herein disclosed special configurations are supposed to be discreet.

In another aspect, wireless charging could be included using Qi charging standard to eliminate the need for a charging port, wherein a low power mode could be implemented that the Passport jumps into when it is instructed to power off, wherein in this low-power mode the Passport could stay on for months or even years, as it awaits a connection from a user with a mobile app.

In another aspect, the Passport could include a custom PCB and a custom LF/HF antenna, and a custom battery, the custom PCB could run a modified Proxmark firmware as well as an on-device translator for making automatic decisions on the fly without human involvement, and where for example the PCB could run various bits of code dependent on badge technology and intended operational mode.

In another aspect, similar to Thor, the Passport connects to a mobile app via BLE, wherein Thor and Passport cannot directly see one another, and wherein the mobile app could be a mediator between the Passport and Thor, which allows for a much more seamless integration between the disclosed devices.

In another aspect, the form of the invention is not to be limited by any part of this disclosure, such that the disclosed system or device could be provided or sold as a Do-It-Yourself (DIY) kit or alternatively, pre-assembled or pre-manufactured.

In another aspect, a set of instructions, printed, published, sold or provided, could embody one or more parts of the invention, such that a DIY assembly instruction set could be provided as any appropriate media type such as audio, images, video, or text instructions either digital or non-digital (e.g. hardcopy), and wherein alternatively, or in addition to such a DIY kit, the system or some of its individual components could be provided or sold pre-assembled.

In another aspect, there could be one or more configuration differences between such a DIY version and a pre-assembled version, wherein, DIY assemblies could include a unique board +shield combination, and wherein such board could run stock Proxmark firmware, while the shield could be connected to the Board and set up for BLE communication with a simple mobile application.

In another aspect, although such a DIY version of the invention could be similar to a pre-manufactured version in outcome functionality, there could be vastly different technologies behind their proper function, wherein in a DIY version a MaxiProx 5375 could be used with a reader issued by HID Global, which can support a HID ProxCard II badge technology, and wherein the system could be hooked up to a Weigand output on such a MaxiProx 5375 and fed into a Board+Shield which sends captured data to the mobile app.

In another aspect, to write a badge, single badge technology could be used or single or multi-badge technologies could be supported.

In another aspect, the passport could be a neck worn device, wherein Thor and Passport could be configured to operate independently of one another but they both may require the mobile app to function.

In another aspect, a mobile app+passport configuration could be supported, wherein, a user could identify, capture, crack, simulate, etc. and do all the features of Thor listed herein, with a more limited range, wherein the passport and thor could have all the same features with the only difference being a shorter range and accompanying components.

In another aspect, Passport would be desirable in the system without Thor, wherein after Thor has already captured several previously, the user does not need to capture more badges since they can use the mobile app to assign whatever badges they want to simulate, brute-force, write, etc., done done via only the Passport.

In another aspect, the mobile app+thor combination can do all the long-range functions described herein, including simulation and brute-forcing of captured badges, wherein Thor could be used simply to capture and crack badges so that they can come back with Passport to gain access to the target facility at a later time after re-uniting with the Passport.

In another aspect, with just Thor, a user would actually be able to automate the identity, crack, capture, and store steps described herein in the mobile app part of the process, and the system could enable one or more previously captured badges to automatically simulate on Thor itself.

In another aspect, using the mobile app+thor+passport will allow for all features and maximum range, wherein thor supports LF and HF badge technologies at long range and has the capability to do more than just capture badges of a single badge technology type, wherein the disclosed system is unique with a custom designed “thor” unit, which ends up providing an all-in-one solution for HF/LF badges, from identification all the way through cracking, capturing, simulation, brute-force, and writing.

In another aspect, it is to be understood that the disclosed system could be a fully-featured solution that is unique over existing systems, the passport is considered unique over prior systems for various reasons, such as being smaller and more discreet than previous systems while having no ports and while having a custom built in battery and wireless charging, and wherein the disclosed system has a unique feature because it has the ability to pair up or communicate with a partner device such as Thor.

In another aspect, using Thor+Passport+Mobile App, a unique and powerful combination is specially arranged that allows automation, streamlining, portability, and accessibility, where the terms “crack” and “brute-force” can take various definitions, wherein cracking a badge could include capturing and decrypting badges that utilize encryption, and encryption on badges is designed to protect a card's contents and badge information to prevent the unwanted capturing of a user's card.

In another aspect, with the disclosed system, the user can decrypt various card types, such as MiFare Classic and HID iClass, and wherein some badge technologies cannot be captured without first decrypting (i.e. cracking), the encryption designed to protect the car, and wherein brute-forcing allows a user to intelligently attempt several different card IDs at a facility's RFID reader that protects a controlled access area, while allowing the other card data fields, such as the facility ID, to remain static. This technique increases both the rate and effectiveness of brute-forcing card data.

In another aspect, the system would use the employee's captured badge as the starting point for brute-forcing operations.

In another aspect, “Thor” device as disclosed herein could be considered a long-range or multifunction RFID device, apparatus, equipment, or tool or this device could be considered a multi-use reader, simulator, writer, etc., as disclosed in various ways herein.

In another aspect, with respect to processes of the system, there are various innovative embodiments that are contemplated, wherein the disclosed process does not require typing code on a computer or android phone, does not require bulky hardware, and allows multiple commands at a time while evaluating the output and results of the command, then, issuing another command based on the condition of the output received, wherein instead, the disclosed system is an automated process by piping the output from one command into the next, or more specifically, detailing when an error has occurred if the previous command was not successful for one reason or another.

In another aspect, the disclosed system could execute specialized code that exists not only in apps that the system runs, but also in the custom circuit boards and firmware specially configured for “Thor” or “Passport”, such that disclosed devices work seamlessly together, and such that the disclosed devices could allow the user to choose an action option from a mobile app in a way that is as simple as pressing a button, then subsequently a command is sent to an appropriate device, wherein:

device #1 could receive a command, execute desired actions, send back the state and output of a command to an app and user, and store the captured data and the status within the app, and wherein subsequently, the app automatically sends the appropriate information and next command set to device #2, wherein this all works in perfect unison between all devices in a way that is automated and/or discreet.

In another aspect, capturing and cloning a Proxcard II card could include: starting a user's mobile session, and using Thor to automatically discover a card type, and once discovered, Thor is set to capture on a detected card type and begins capturing badges when in range, and wherein at this point, this information is relayed to a user in a user-friendly way via the mobile app.

In another aspect, when a badge is captured and auto-clone or auto-simulate is enabled, it is captured by Thor, and sent to a mobile app for storage and user notification, automatically sent to Passport, and/or the process of writing or simulating is conducted, this disclosed seamless command and control of the three different devices and the hand-off or passthrough of information and data is one element (among many) that provides unique utility.

In another aspect, the automation processes leverage the resulting output of one command to automatically create and formulate the next command, which then creates the next, all discreetly and automatically, while handing or handling data between all three devices, wherein the user could simply see a status icon such as, “Detecting badge. Badge Detected: MiFARE Classic. Attempting to crack the encryption 1/3. Attempting to crack the encryption 2/3. Attempting to crack the encryption 3/3. Badge crack successful! Captured MiFARE badge. Simulating MiFARE badge of Passport.”

In another aspect, the user does not see the code that is being run, and in the event of an error, problem, or issue, the user receives more detail, suggestions on what to try differently, or becoming notified/alerted if a targeted badge is not vulnerable to cracking.

In another aspect, the hand-off and command and control of all devices is done via a centralized, easy to use, code-free (from a user perspective), and automated fashion.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 schematically presents capturing and/or cracking a badge from a valid employee discreetly, in accordance with aspects of the present disclosure;

FIG. 2 schematically presents sending a captured or cracked badge to a mobile phone via a wireless communication technology, in accordance with aspects of the present disclosure;

FIG. 3 schematically presents various options for using badge data, including writing, simulating, and brute-forcing, which would take place on a neck worn passport lanyard, in accordance with aspects of the present disclosure;

FIG. 4 schematically presents a passport, “thor”, and app elements of the system, in accordance with aspects of the present disclosure;

FIG. 5 schematically presents a method of providing a cracked passport that visually looks like a generic RFID badge holder, and a thor device having a battery, Bluetooth, and a custom board and hardware with integrated HF and LF antennas, in accordance with aspects of the present disclosure;

FIG. 6 shows a perspective view of an example badge holder, in accordance with aspects of the present disclosure;

FIG. 7 shows a front view of a user wearing an example badge holder, in accordance with aspects of the present disclosure;

FIG. 8 shows an exemplary physical environment where a pentester is in range of a secure building and/or employee RFID badge, in accordance with aspects of the present disclosure;

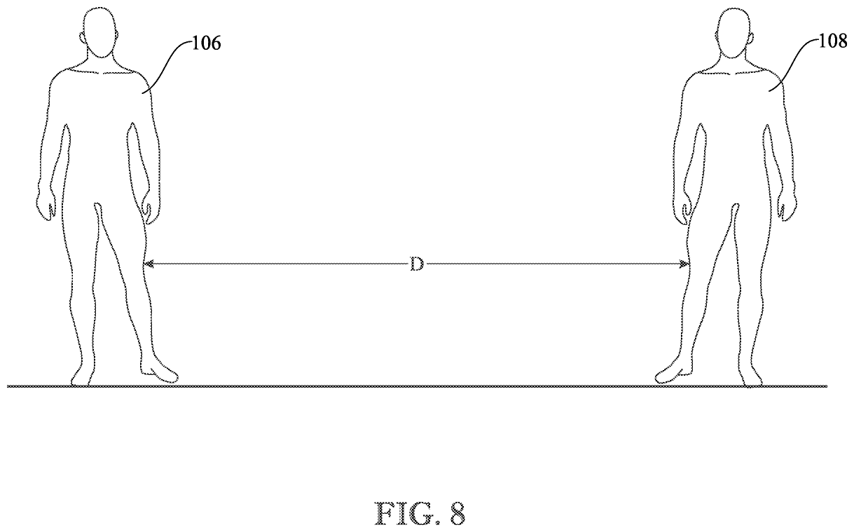

FIG. 9 schematically shows an example situation where a disclosed device has yet to identify or break target badge encryptions, in accordance with aspects of the present disclosure;

FIG. 10 schematically shows an example situation where a disclosed device has completely identified or broken target badge encryptions after identifying the badges, in accordance with aspects of the present disclosure;

FIG. 11 schematically shows a personal electronic device displaying exemplary notifications about unlocking badges through a graphical user interface (e.g. LCD display or Augmented Reality), in accordance with aspects of the present disclosure;

FIG. 12 schematically shows an example physical situation where a pentester is at an appropriate distance for secretly capturing an RFID badge of an employee, in accordance with aspects of the present disclosure;

FIG. 13 schematically shows various operational elements of the disclosed system, including a mobile app, a multifunction badge identification and cracking device, and a passport device allowing access using cracked badge information received through the multifunction badge identification and cracking device, in accordance with aspects of the present disclosure;

FIG. 14 schematically shows an example method for granting access via a simulated badge, in accordance with aspects of the present disclosure; and

FIG. 15 schematically shows an example method for sending a badge to a simulator or a mobile app, in accordance with aspects of the present disclosure.

Like reference numerals refer to like parts throughout the several views of the drawings.

### DETAILED DESCRIPTION

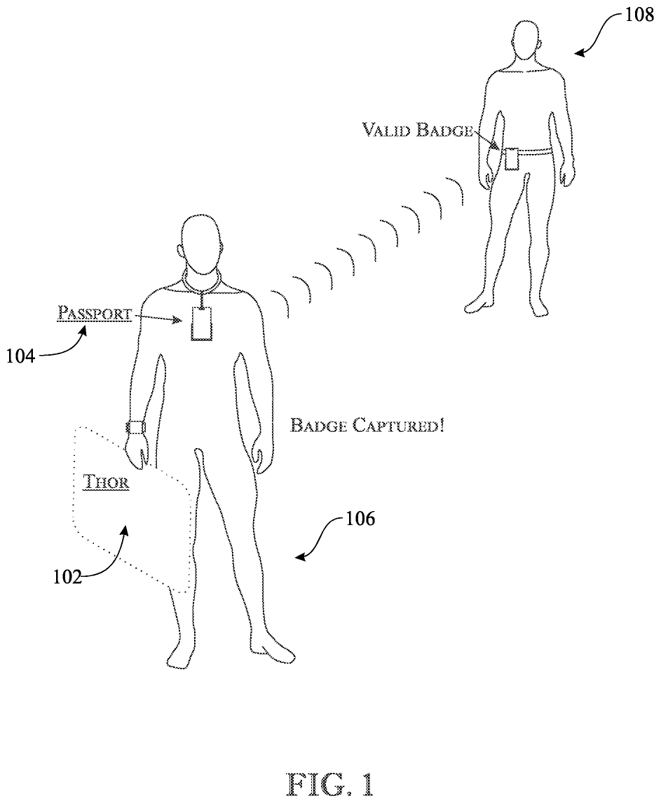

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures is a method of streamlining a process of capturing, cloning, cracking, and brute-forcing RFID access badges. As a non-limiting example, the method provides a way to effectively demonstrate real-world security risks affecting organizations across the globe.

The illustration of FIG. 1 schematically presents capturing and/or cracking a badge from a valid employee discreetly. More particularly, a capture and cracking device 102 (“Thor”), a simulator device “Passport” 104, a pentester 106, and a valid badge 108 are shown to convey an example situation where the disclosed system could be used as described in further detail below. It is to be understood that the disclosed system could support Proxcard II, EM4100, and Indala for low-frequency embodiments and IClass Standard Security/SS/Legacy, and MIFARE Classic for high-frequency embodiments. But although these are suggested herein, the spirit and scope of this disclosure is not to be limited to such elements.

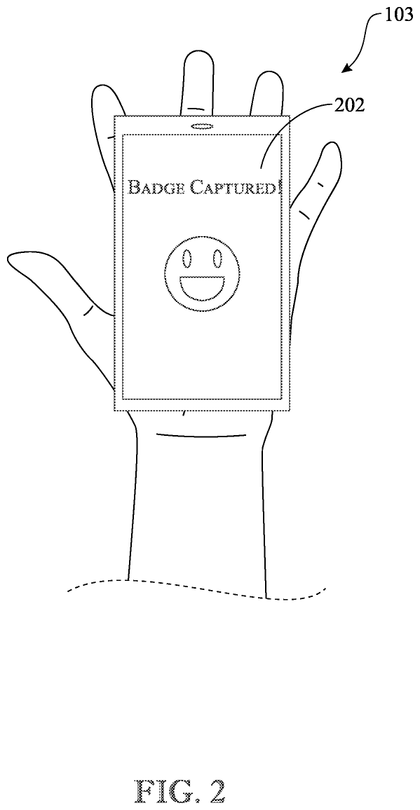

The illustration of FIG. 2 schematically presents sending a captured or cracked badge to a mobile phone via a wireless communication technology. More particularly, mobile phone 103 is displaying information on a graphical user interface 202 relating to a capturing operation as further detailed below. As a non-limiting example, this phone app could automatically notify users when badges are captured, or notify users of other information such as a location of an unlocked room, etc. Such device 103 could be any appropriate mobile computing device or even a laptop or desktop in some situations. The GUI could be displayed on any capable device. As such, it is to be understood that the capturing device 102 could be operated independent of the passport device 104, since all the passport device 104 needs to operate is a properly captured badge ready to be simulated. In other words, the passport device 104 could receive captured badge data sometime after it was captured (e.g. hours, days, weeks later), and furthermore, the passport device 104 could work any distance from the capturing device 102 as long as it is properly interconnected with the system to receive the data it needs to simulate badges.

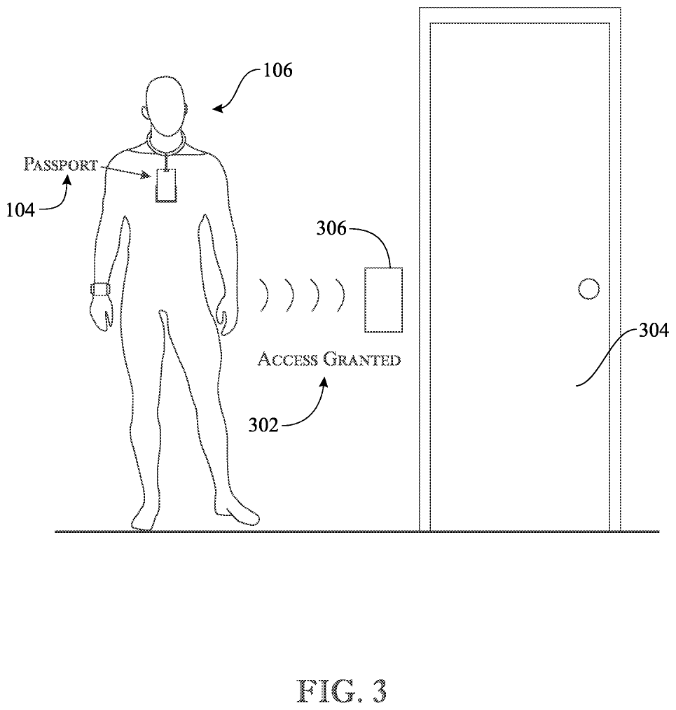

The illustration of FIG. 3 schematically presents various options for using badge data, including writing, simulating, and brute-forcing, which would take place on a neck worn passport lanyard. More particularly, access is granted at 302 because the passport 104 is in range with a door lock reader 306 for a potentially locked door 304. The pentester 106 in this situation would either have already been notified that the simulation is ready or may have already been notified on new and specific access (e.g. exact door #).

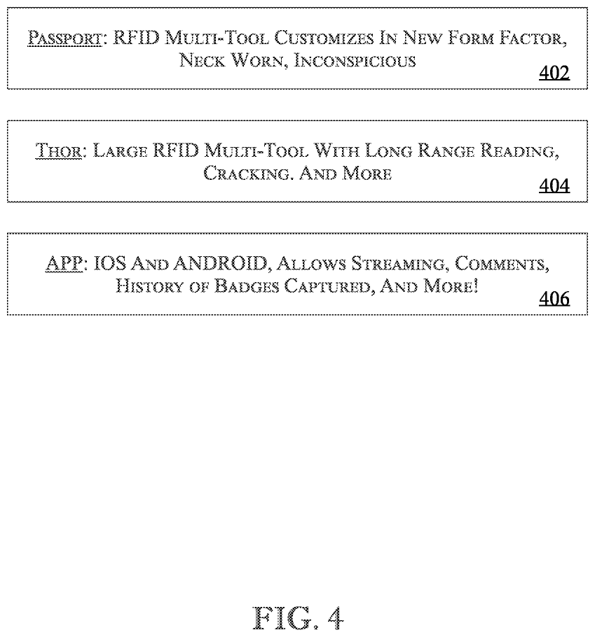

The illustration of FIG. 4 schematically presents a passport, “thor”, and app elements of the system. More particularly, at 402 the figure shows various core components, which include an RFID multi-tool for the passport at 402, a large RFID multi-tool for thor (capture device) at 404, and an iOS or Android operating system for the mobile app at 406. As a non-limiting example, the RFID multi-tool could be a device configured to read and pretend to be an RFID tag, and detect communications between an RFID tag and a reader, while being able to operate in standalone mode (without the need for a personal computer.)

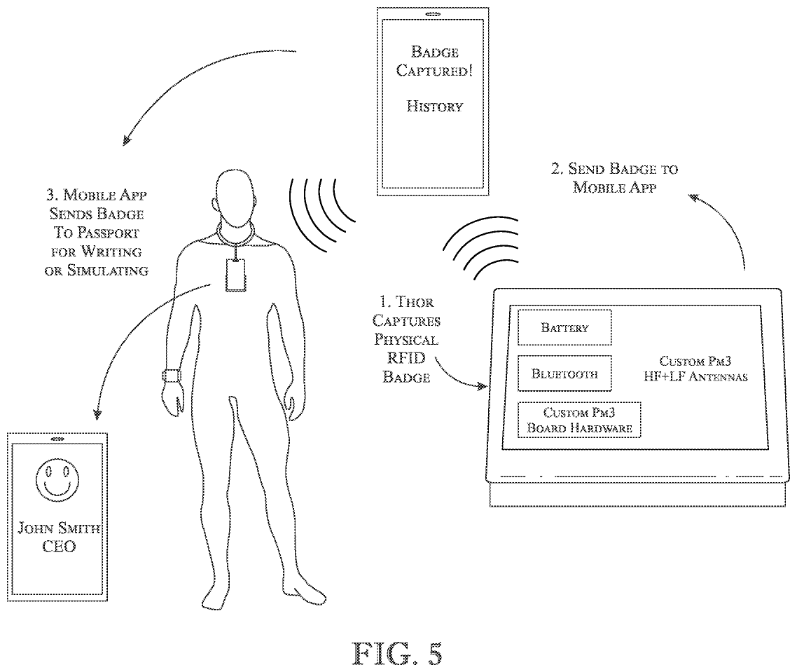

The illustration of FIG. 5 schematically presents a method of providing a cracked passport that visually looks like a generic RFID badge holder, and a thor device having a battery, Bluetooth, and a custom board and hardware with integrated HF and LF antennas. More particularly, the figure shows a pentester 106 having a passport 104 which is communicating over Bluetooth to a mobile phone 103 (and GUI 202), and where thor 102 also communicates with the mobile phone app wirelessly. The figure furthermore shows that thor 102 could include a battery 502, a Bluetooth module 504, a custom board 506, and HF and LF antennas at 508.

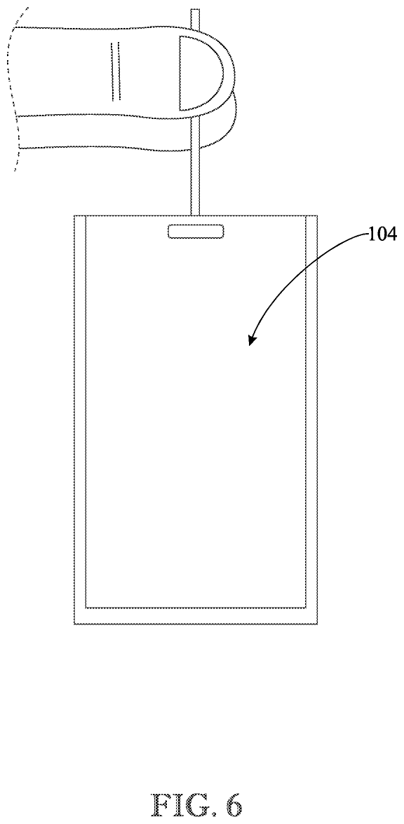

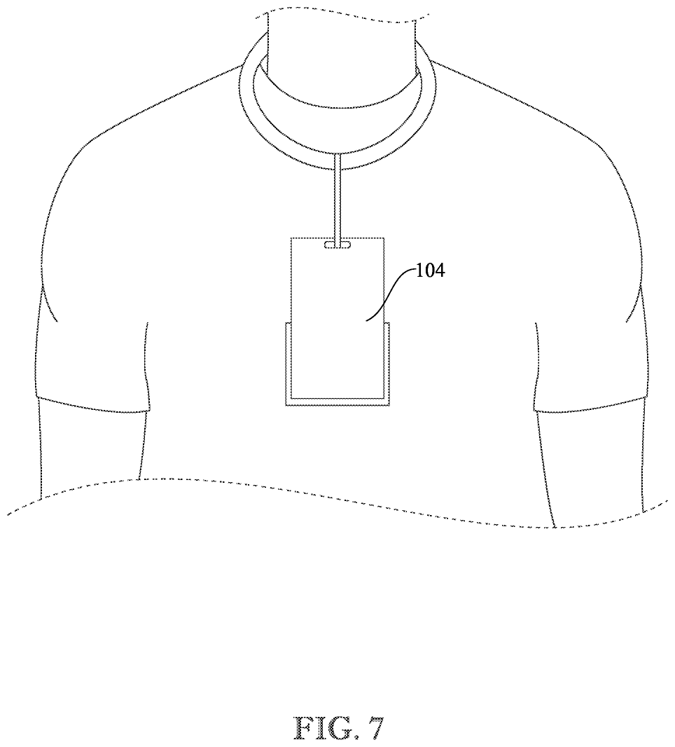

The illustrations of FIGS. 6-7 show a perspective view of an example badge holder 104 (passport) and a front view of a user wearing the example badge holder.

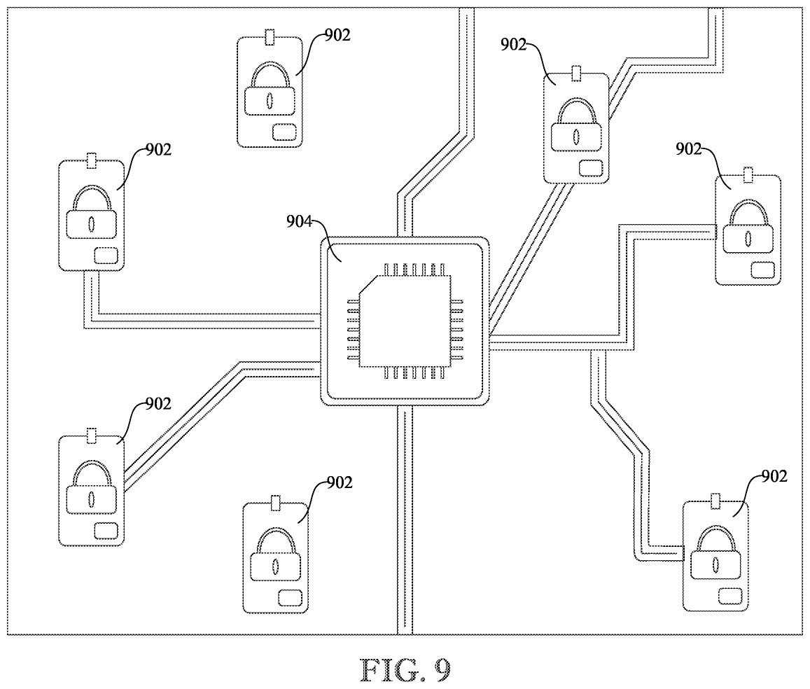

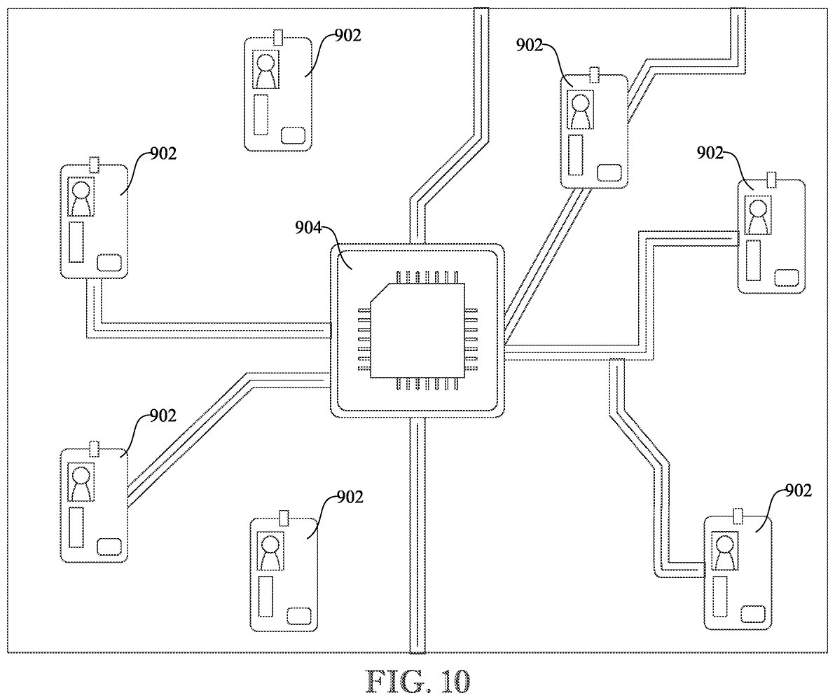

The illustration of FIG. 9 schematically shows an example situation where a disclosed device has yet to identify or break target badge encryptions 902, and FIG. 10 shows the badge encryptions having been unlocked by the system at 1002. Device 904 could be capture device 102 of FIG. 1, as a non-limiting example.

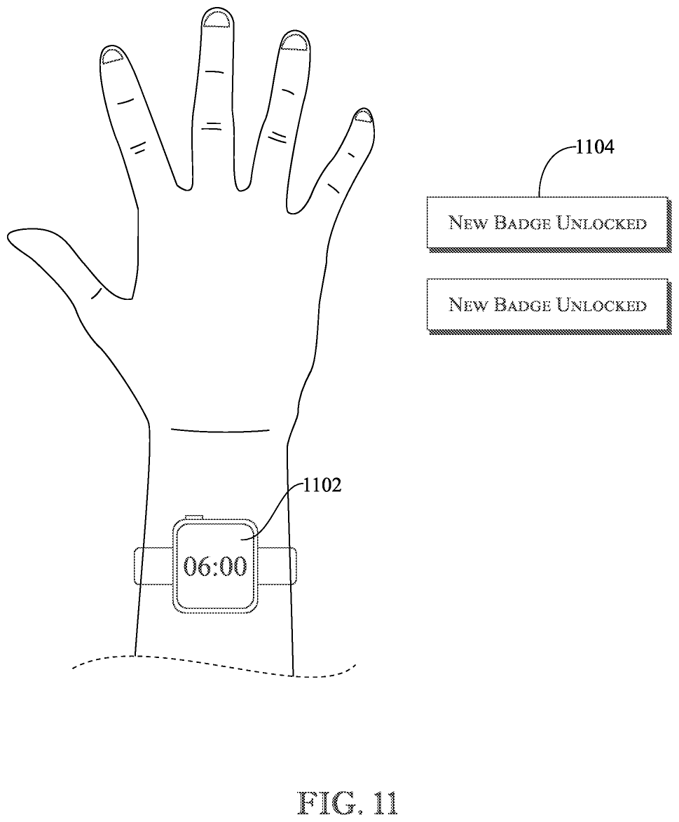

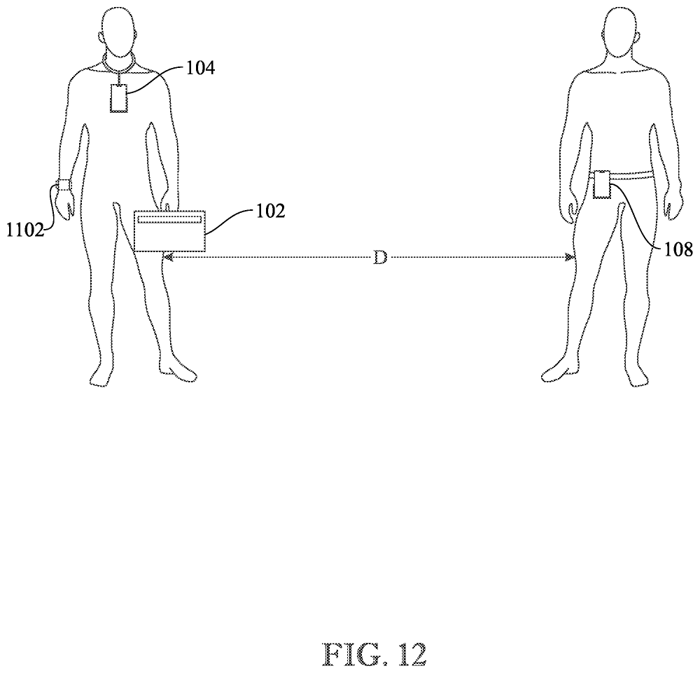

The illustration of FIG. 11 schematically shows a personal electronic device 1102 displaying exemplary notifications 1104 about unlocking badges through a graphical user interface (e.g. LCD display or Augmented Reality). These notifications are a result of having successfully identified, cracked, and captured a badge, and they are configured to let the user know that they may use a newly unlocked badge. As shown in the figure, several notifications can be listed in a row but any appropriate graphical method could be used to convey this information. FIG. 12 schematically shows an example physical situation where a pentester is at an appropriate distance for secretly capturing an RFID badge of an employee, where the passport 104 is worn around a neck of a pentester while the pentester checks a mobile device 1102 notification about information received via the capture device 102. In this instance, the capture device 102 is shown having been discreetly secured and carried in a briefcase or bag. In some examples this bag could be purposefully left in an area to gather and capture badges for later retrieval (e.g. downloaded from the device 102 or from “the cloud” via cellular technologies such as 3G/4G/5G or Wi-Fi). An employee badge is shown at 108 ready to be captured or that has already been captured. As a nonlimiting example, the captured badge could provide access to special elevator control (specific floor access) or a specific door.

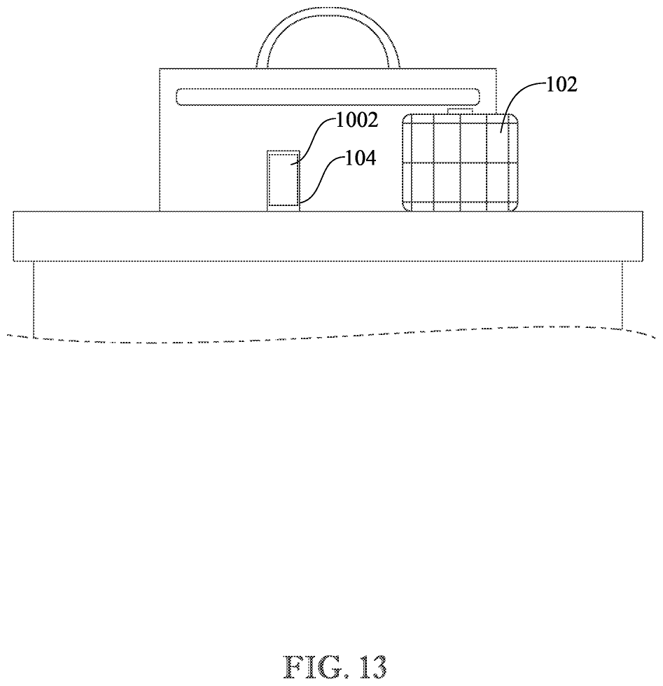

The illustration of FIG. 13 schematically shows various operational elements of the disclosed system, including a multifunction badge identification and cracking device 102 (capture device), a passport device 104, and an unlocked badge 1002, allowing access using cracked badge information received through the multifunction badge identification and cracking device 102.

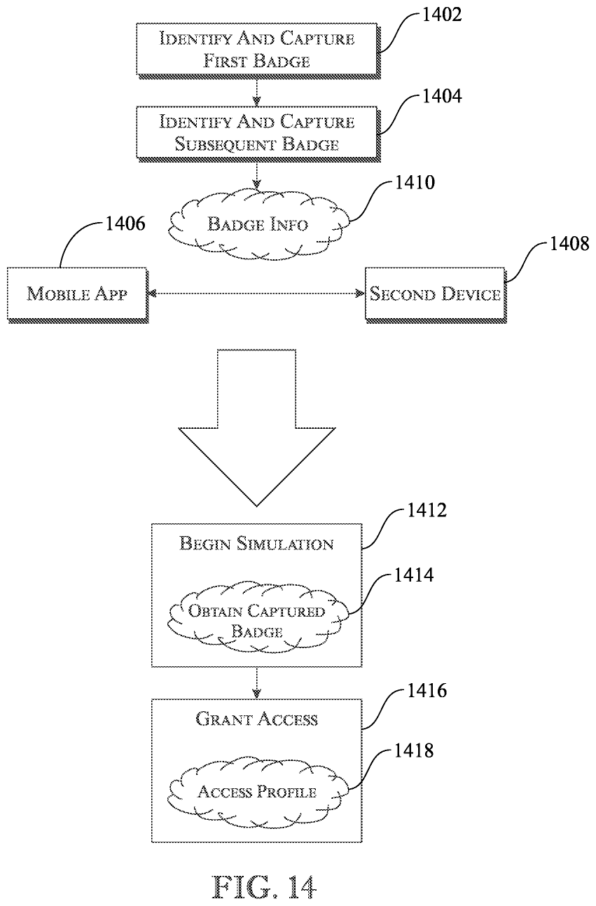

The illustration of FIG. 14 schematically shows an example method for granting access via a simulated badge. More particularly, at 1402 a first badge is identified and captured, at 1404 a subsequent badge is identified and captured, and at 1410 badge information is transferred or made available to a mobile app at 1406 or a second device at 1408. Furthermore, simulation begins at 1412 once a captured badge is obtained at 1414, and access is granted at 1416 based on an access profile 1418 of an original captured badge.

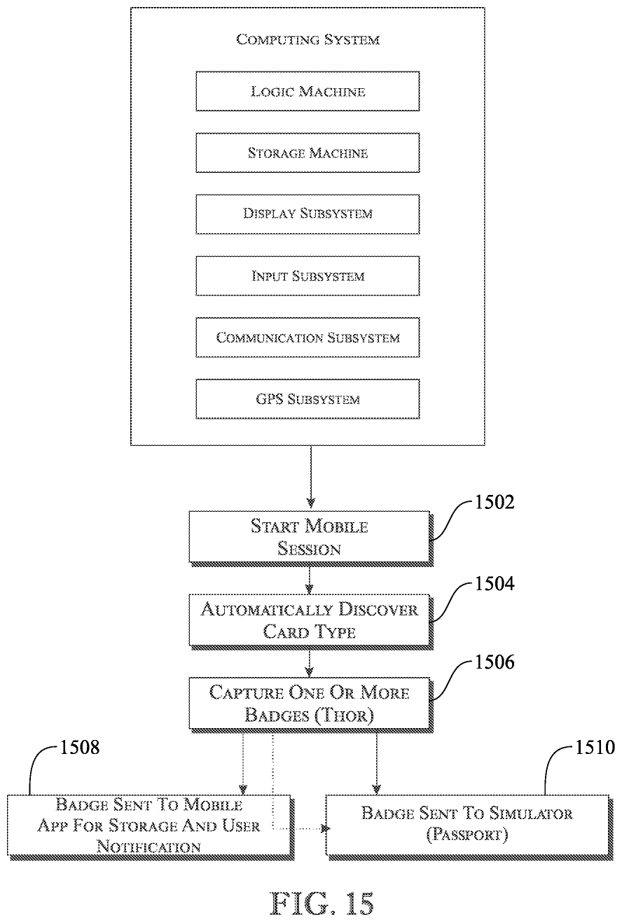

The illustration of FIG. 15 schematically shows an example method for sending a badge to a simulator or a mobile app. More particularly, at 1502 a mobile session is started, at 1504 a card type is automatically discovered (e.g. via capture device 102 above), at 1506 one or more badges are captured (e.g. via capture device 102), at 1508 a badge is sent to a mobile app, and at 1510 a badge is sent to a simulator (passport 104).

There are multiple parts to the disclosed invention. As a first part, an RFID antenna (which could be about the size of a closed laptop) is included. Such an RFID antenna could fit inside a standard laptop messenger bag, as a non-limiting example. The RFID antenna could be battery powered, operating over Bluetooth via a mobile app. As yet another non-limiting example the RFID antenna could include a High-Frequency and Low-Frequency antenna. As yet one more non-limiting example, the RFID antenna could operate at up to a 6 ft distance. However, it is to be understood that this distance or any value mentioned herein is merely suggested as an example or approximation and is not intended to limit the scope of the disclosure. The disclosed systems could operate at any appropriate distance allowable by the configurations suggested herein. These configurations allow the disclosed system to capture, clone, simulate, brute-force, crack, etc. nearly every type of RFID access badge.

The disclosed system solves problems mentioned in the background section. For example, the disclosed system could be considered an “all-in-one” RFID device which eliminates the necessity of combining or integrating several discrete systems to achieve the abilities and functions described herein.

As a non-limiting example, the disclosed system could be an all-in-one RFID device that combines the ability for the communication between various parts of the disclosed system via HID MaxiProx 5375 (e.g. capable of reading badges 3 feet away), and reading Proxcard II type badges. Both of these technologies could be usable simultaneously. Concurrently, the disclosed system simulates and brute-forces the system in situations where badges are read or interacted with. The disclosed system allows for long-range reading and various other functions as detailed herein, where these functions could relate to either or both LF and HF frequencies (e.g. at approximately 3 ft range), all via one unit of this herein disclosed system.

The disclosed system allows for penetration testing and security assessment by demonstrating existing vulnerabilities in technologies. Through the provided examples herein, the disclosed system is highlighted. For example, it is to be understood that the disclosed system is configured to allow a skilled technician to identify areas of a security system that are lacking protection in a streamlined and effective way. As a non-limiting example, the disclosed features and functions can be provided without the need for carrying various gear, inconveniently typing lines of code or commands, and the need to use an inconvenient plurality of terminal prompts to demonstrate vulnerabilities. The disclosed methods and/or systems provide a streamlined way to highlight the concept that a particular RFID access control system can be flawed and could require upgrades.

The disclosed system could be used as reader replacements for various types of organizations, as one non-limiting example.

For pentesters, the system provides a useful ability to crack and/or clone RFID access control badges in unique ways. For example, using Proxmark3 open-source hardware and firmware (i.e. a combination of the two), it is possible to use the system without needing two separate antennas (e.g. one high frequency and one low frequency), which merely would achieve an inch or two inches at the most, and without needing to type the above mentioned extra commands. Instead, the disclosed unique system improves upon this issue and removes such restrictions, allowing a pentester to walk into a client's site, walk past target people, and/or stand next to a target person in the elevator, while concurrently capturing and cloning their badges from several feet away (e.g. up to 6 feet), and further allowing access into the building using that target person's identity. This allows the pentester to demonstrate massive vulnerabilities in access control systems that are infiltrated using the disclosed system. Although the term “pentester” could be used herein for defining an individual that uses the system to, for example, crack a target badge, this definition is not meant to be limited in any way. For example, the user could be an information security consultant, security auditor, a cybersecurity penetration tester, or any professional paid to test security systems of companies.

As a non-limiting example, the disclosed system can be used to demonstrate, in real time, the cracking of MIFARE CLASSIC badges without typing any complicated commands while assisted by a beautiful and elegant mobile application (e.g. on a smart phone operating system).

In broad view, a core part of the operation of the disclosed system is a Proxmark3 open-source firmware and custom modified hardware to run the Proxmark3 source code. A specially configured long-range antenna combinations (e.g. both LF and HF) interfaces directly with a Proxmark3 backend code. A mobile app could be configured to be responsible for sending commands while receiving data to make decisions and write, emulate, brute-force, store history, etc. of all badges during an assessment. A mobile app could be a custom defined set of automatically executing tasks responsive to user input. The app could be automatically run by way of one or more processors (e.g. logic machines). As a non-limiting example, the mobile app could be custom made and the antenna hardware could also be custom made due to the unique set of abilities of the disclosed system.

The above mentioned elements are merely provided as examples and are not intended to limit the spirit or scope of this disclosure. For example, the proxmark3 element could be any appropriate open-source protocol with the assumption that the protocol has to enable the herein disclosed features. The MIFARE CLASSIC element is mentioned as an example badge therefore it is to be understood that any appropriate device could be cracked (e.g. as a target device) without departing from the scope of this disclosure.

The majority of the disclosed system could be assembled into a volume similar to that occupied by a closed average laptop. The system could have antennas surrounding outside edges internally that allow the system to communicate with low-frequency and high-frequency access control badges of various technologies. As a non-limiting example, the device could have the dimensions 12.0″×12.0″×1.0″ (30.5×30.5×2.54 cm).

It is to be understood that the disclosed system allows full support of all technologies by leveraging Proxmark3 code and including specialized, custom designed LF and HF antennas. Furthermore, the disclosed system has the ability to both read, crack, and clone badges. The disclosed system is a perfect way to expose areas of weak security. In other words, the disclosed system captures and clones a target access badge quickly and discreetly and could be used in various goals such as exposing security risks relating to access badges.

It is to be understood that although Proxmark is mentioned as a tool it is to be understood that any appropriate tool could be used to accomplish the functions described herein. For example, a dev kit could be included with highly customizable antennas, and furthermore, multifunction multiplexing interface could be supported. As a non-limiting example, an external battery, high-powered antenna, and Bluetooth interface could be included.

In one example, the system includes a unique and custom configuration of an LF and HF antenna, providing the various abilities described herein in addition to the ability to read badges. In other words, these LF and HF antennas may provide a proprietary dual-band LF/HF antenna arrangement that provides utility at long-range and the ability to identify, write, simulate, brute-force, and crack badges at such long ranges. As a non-limiting example, “long range” could be defined as having utility in any context described herein at at least 6 ft of distance between a target device and any of the disclosed systems, devices, antennas, or any wireless communicator subsystems. For example, the distance could be the distance between a “passport” device and a target device, as disclosed herein. Or, as yet another example, the distance could be defined as a distance between “thor” and a target device. It is to be understood that this distance is not mentioned here to limit the invention. Instead, this distance is mentioned here as an example and various approximations could be assumed given approximations known to the art. For example in some instances even 5 feet could be considered long range.

Identifying badges at long range could include scanning an entire LF and HF spectrum. This identifies an unknown badge technology, perhaps from a blank RFID card. This is an improvement over known methods because it allows for such identification to occur at distances far beyond the current standard of just a few inches. Using the current system, this step of identification could be done several feet away from a target device (i.e. long range) using “thor” described in detail herein.

Writing badges at these long ranges could include writing data to a compatible badge. This could be a T5577 badge, or the like, as a non-limiting example. As mentioned above this would happen at long-range.

Simulating badges at long ranges could include using “thor” to digitally broadcast a badge signature from long-range.

Brute-forcing badges could include using “thor” to intelligently, automatically, effectively, and conveniently, simulate a badge ID while positioned near an RFID door reader (or the like) from long range. For example such simulating a badge could occur in sequence a plurality of times to simulate badge IDs, one after the other. As a non-limiting example, this process could take seconds, minutes, or sometimes hours but will eventually simulate a right combination of a valid badge ID and a door reader will unlock and provide access to a target area.

Cracking badges could include cracking an encrypted badge (e.g. badges such as MiFARE Classic varieties). For example, vulnerabilities in such badges could be leveraged using “thor” to crack the badges at long distances. This could be done automatically via the disclosed systems, configurations, processes, or methods. This could be done seamlessly for the user, without requiring prior experience in RFID technology, experience with specialized equipment, or typing code into a computer program.

It is to be understood that the herein disclosed specialized antennas can provide the abilities mentioned herein in any appropriate way. For example, one way would be to include a specialized combination and pairing of custom-designed hardware and custom-software development. Using this method the system is able to achieve more than just “reading” badges, because the system can identify, crack, write, simulate, and brute-force badges due to the one-of-a kind combination of the disclosed elements as explicitly or non-explicitly suggested herein.

As a non-limiting example, using “thor”, a user can identify, crack, and capture a badge from several feet (e.g. 6 ft) away. Once captured, this badge could be stored in a user's badge library, which could be encrypted, and which could reside in a mobile app. From here a user could choose to “simulate” any supported badge type in their mobile app library of captured badges.

When simulating, either the “passport” or “thor” can provide simulation operations. The “passport” is sleek and discreet and is perfect for security assessments, whereas Thor can simulate at long-distances. If “passport” is simulating and the user is wearing it around their neck, they would bring the passport within range of the RFID reader on the wall to unlock doors and other areas that would normally require authorization using the target device. In other words, a locked area that is accessible via a target device would become accessible using the “passport” and/or “thor” device (appropriately selected for context). If “thor” is simulating at long range, the user may be able to simply walk right into locked doors. Due to the long-range simulation power of “thor”, it would be able to trigger a door access reader as one would normally enable their passage through the doors.

The scenarios above disclose a step-by-step process where the user chooses to simulate a badge from their library. It is to be understood that this entire process can be automated through a mobile app. For example, a user could set a mode to “automated” and choose to automatically simulate a most recently captured badge. This could be what a scenario looks like for a user who has no idea what badge technology is being used at a target location, making the utility of the invention more universal.

For example, while “thor” and “passport” are connected, a user could set the app to “automated mode” or Thor could jump to “identify mode”. In this mode, Thor scans for low and high frequency signals to identify the badges used by employees. Once close enough to a badge-wearing employee, Thor would automatically detect a badge type and thor would automatically switch to that badge technology type.

Once “thor” switches (automatically based on the previous automated step), Thor would jump into “capture” mode for that badge technology that it has identified and capture a next badge it recognizes or sees (at long range). If thor attempts to capture an encrypted technology, like MiFare Classic, Thor would then immediately jump into the appropriate phases of cracking the badge.

Once completely captured and the cracking process is successful (if applicable), the information will be sent from Thor to a mobile app stored in a library and then that information could be sent from the mobile app to the passport. Passport would immediately begin the simulation process of a successfully captured badge.

An automated scenario could include executing any of the above mentioned steps in 3 seconds or less, as a non-limiting example. This example 3 seconds could be three seconds starting from the time a badge is captured and ending at the time it is being simulated and ready for use by the passport. Overall, as long as the devices are in some range (the range limited by the selected hardware), the system is able to execute any of the disclosed methods in a matter of 3 seconds or even less. Some badges would require cracking before being captured and this would potentially inflate the time to complete the process.

The above mentioned parameters can be set within the mobile app such that Thor and Passport can execute all the herein mentioned processes automatically such that a user receives an alert and status updates along the way. This could also include notifying when a Passport is simulating a badge that is ready to use on a doorway.

The brute-force technology leverages a previously captured badge as an intelligent (e.g. via machine learning) starting point. In one example of a security assessment, a user captures a badge of a janitor that gets the user into door #1 and door #2, but does not allow access to door #3 because door #3 is a server room or other critical access area. The user could use the disclosed suite of elements (i.e. the system) to brute-force door number 3 given one or more previously captured badges. Once the user captures the initial employee badge and realizes that the badge they have does in fact provide desired access to a specific part of the facility.

As a non-limiting example, the user could select which badge from their captured library (e.g. in the app) to be a starting point for a brute-force operation, and whether they would like to use passport or thor for this process. The use could select “begin” (or similar) on the mobile app to begin this process. The mobile app could instruct thor or passport (depending on which one the user chose to use) to simulate one badge after the next until the door unlocks. This process could be done automatically at very rapid speed to brute force any suitable target system. For example there could be code running in the background that makes the process as easy as selecting a starting point and selecting “go”—from a user's perspective. This is due to the disclosed unique arrangements and combinations of custom hardware and software.

A process flow for cracking could include, once a badge technology has been identified and is in range, determining if the badge technology is one that requires cracking. This could be done via the mobile application or Thor. As a non-limiting example, the mobile app locates known and well-documented vulnerabilities for the encrypted card type and begins to execute an attack one after the other. Using the disclosed system, commands that typically are required for existing technologies such as MiFARE Classic are run automatically and dynamically based on the output received of the command that precedes it. This process (or any other process herein) could be executed transparent to the user and the user would only know the badge technology was encrypted because the app notifies the user that the technology is/was an encrypted card type and that it was successfully cracked. In a status update or notification, the user would see that Thor reports, “Please wait, cracking MiFARE Classic Badge. This should only take a few more seconds . . . ” Once cracked, decrypted badge information could be sent to the mobile app for storage, where it can then be sent to Passport (or back to Thor) for brute-forcing, writing, or simulating.

Various hardware described herein could be customized in special ways to run the Proxmark3 source code (or the like). For example, the specialized antennas can connect to or communicate with the Proxmark3 backend code. The specialized antennas could be located (e.g. lined) around and/or along one or more edges of the device.

With respect to Thor, a custom printed circuit board (PCB) could be used to run the Proxmark firmware, which also contains a Bluetooth low energy (BLE) chip. The BLE chip allows communication with the mobile app. A custom “shield” could be included for the hardware to perform on-device translation and decision-making capabilities elegantly within Thor itself. The system could include a custom-designed battery to power all of these features. But it is to be understood that any appropriate power technology could be used (e.g. batteryless and wireless power transfer).

In some instances, the Proxmark code or various other parts of the system such as the custom hardware could be modified for the purpose of making the most out of Thor's unique capability and feature set. This herein disclosed improvement was developed because the stock Proxmark code and existing hardware does not have the ability to simply “plug and play” an antenna like Thor, and to access the herein described features. In other words, Thor could be built from the ground up, specifically and specially for the purposes described herein. The PCB and shield could be custom designed such that Thor can be optimally and maximally leveraged and such that remote commands and captured data can be sent and received between the mobile app and thor (or between one or more of the disclosed elements. These commands or data could be used in any appropriate way between the various elements (e.g. thor or mobile app), or sent to Passport for additional operations and functionality.

With respect to the Passport, as shown in the figures, this could be a neck-worn piece design to be portable, wireless, and completely discreet. Among others in this disclosure, this is a unique configuration. It has a compact size and unique utility.

In some examples, the Passport has no buttons, LEDs, switches, toggles, ports, or anything that would make the Passport appear to be something other than what it is imitating (to blend in). As a non-limiting example, if one were to inspect this device, they may be led to believe it is a light and small piece of plastic that would normally resemble an RFID badge holder that is commonly found. The disclosed device resembles the badge in imitation of the visual appearance and/or weight of the badge. It is to be understood that although the present disclosure mentions that one or more elements attempt to “resemble another” device, this is not to be understood as an admission to prior art. Resembling another device is done for cosmetic and perception purposes because the herein disclosed special configurations are supposed to be discreet.

Wireless charging could be included using Qi charging standard to eliminate the need for a charging port. A low power mode could be implemented that the Passport jumps into when it is instructed to power off In this low-power (i.e. standby mode), the Passport could stay on for months or even years, as it awaits a connection from a user with a mobile app.

The Passport could include a custom PCB and a custom LF/HF antenna, and a custom battery. The custom PCB could run a modified Proxmark firmware as well as an on-device translator for making automatic decisions on the fly without human involvement. For example the PCB could run various bits of code dependent on badge technology and intended operational mode. Similar to Thor, the Passport connects to a mobile app via BLE. Thor and Passport cannot directly see one another, in some examples. For example, the mobile app could be a mediator between the Passport and Thor (e.g. via Apple Watch, iPhone, Android, MacOS, iPad, etc.), which allows for a much more seamless integration between the disclosed devices. Furthermore, it helps keep the processes in proper order and controlled. Passport and Thor could be capable of the same feature set. But, in some examples these devices include different elements configured for different purposes due to their differing form factors, power requirements, and intended uses.

It is to be understood that the form of the invention is not to be limited by any part of this disclosure. For example, the disclosed system or device could be provided or sold as a Do-It-Yourself (DIY) kit. A set of instructions, printed, published, sold or provided, could embody one or more parts of the invention. For example, a DIY assembly instruction set could be provided as any appropriate media type such as audio, images, video, or text instructions either digital or non-digital (e.g. hardcopy). Alternatively, or in addition to such a DIY kit, the system or some of its individual components could be provided or sold pre-assembled.

There could be one or more configuration differences between such a DIY version and a pre-assembled version. As a non-limiting example, DIY assemblies could include a unique board+shield combination as described herein through various embodiments. Such board could run stock Proxmark firmware, while the shield could be connected to the Board and set up for BLE communication with a simple mobile application.

Although such a DIY version of the invention (which could include assembly instructions) is very similar to a pre-manufactured version, there could be vastly different technologies behind their proper function. For example, in a DIY version a MaxiProx 5375 could be used with a reader issued by HID Global, which can support a HID ProxCard II badge technology. The system could be hooked up to a Weigand output on such a MaxiProx 5375 and fed into a Board+Shield which sends captured data to the mobile app. To write a badge, single badge technology could be used without departing from the scope of this disclosure. Therefore, it is to be understood that single or multi-badge technologies are supported and that this single-badge technology is only mentioned here as a non-limiting example.

It is to be understood that the passport could be a neck worn device. Thor and Passport could be configured to operate independently of one another but they both may require the mobile app to function.

As one non-limiting example, a mobile+passport configuration could be supported. In this particular configuration, a user could identify, capture, crack, simulate, etc. and do all the features of Thor listed herein, with a more limited range. In other words, the passport and thor could have all the same features (in some embodiments) with the only difference being a shorter range and accompanying components. This could be mainly due to form factor restrictions of the Passport. For example, the passport could provide many or all of the functions of Thor but within a few inches of range depending on the badge technology being targeted. This limited range of Passport is one of the reasons Thor is required in some embodiments.

There is one example situation where Passport would be desirable in the system without Thor. In this example, after Thor has already captured a bunch of badges previously, the user does not need to capture more badges since they can use the mobile app to assign whatever badges they want to simulate, brute-force, write, etc. This could be done via only the Passport.

More particularly, the mobile app+thor combination can do all the long range functions described herein, including simulation and brute-forcing of captured badges. Thor could be used simply to capture and crack badges so that they can come back to the Passport later to gain access to the target facility at a later time after re-uniting with the Passport. A user could just use Thor but the process would not be as streamlined because Thor cannot “capture” badges at the same time it is simulating badges. So the user would need to stop Thor from capturing and then using the mobile app, select a badge to simulate or brute-force, etc.

With just Thor, a user would actually be able to automate the identity, crack, capture, and store steps described herein in the mobile app part of the process. In some embodiments, the system could enable one or more previously captured badges to automatically simulate on Thor itself.

Using the mobile app+thor+passport will allow for all features and maximum range. It is to be understood that thor supports LF and HF badge technologies at long range and has the capability to do more than just capture badges of a single badge technology type. The disclosed system is unique with a custom designed “thor” unit, which ends up providing an all-in-one solution for HF/LF badges, from identification all the way through cracking, capturing, simulation, brute-force, and writing. It is to be understood that the disclosed system could be a fully-featured solution that is unique over existing systems.

The passport is considered unique over prior systems for various reasons, such as being smaller and more discreet than previous systems while having no ports and while having a custom built in battery and wireless charging. The disclosed system has a unique feature because it has the ability to pair up or communicate with a partner device such as Thor. With the disclosed system, (e.g. Thor+Passport+Mobile App), a unique and powerful combination is specially arranged that allows automation, streamlining, portability, and accessibility.

The terms “crack” and “brute-force” can take various definitions. For example, cracking a badge could include capturing and decrypting badges that utilize encryption. Encryption on badges is designed to protect a card's contents and badge information to prevent the unwanted capturing of a user's card. With the disclosed system, the user can decrypt various card types, such as MiFare Classic and HID iClass. Such example badge technologies cannot be captured without first decrypting (i.e. cracking), the encryption designed to protect the card.

Brute-forcing allows a user to intelligently attempt several different card IDs at a facility, while allowing the other card data fields, such as the facility ID, to remain static. For example in a typical use case a user could capture the RFID card of a janitor. The janitor's card in this situation provides access to a front door and an elevator but not to the server room. In this example, the disclosed system performs an intelligent brute-force operation while at a locked server room door. Although the janitor's badge does not work, many fields, such as the facility ID will remain the same between employees. This makes brute forcing attempts possible.

As another non-limiting example, the janitor's card could have an employee ID of 100. The system would use the janitor's captured badge as the starting point for brute-forcing operations. Therefore the operation would then begin by simulating ID #101, then 99, then 102, then 98, then 103, then 97, and so on and so forth. By simulating the badge IDs one after the other, it may take seconds, minutes, or even hours, but eventually the proper badge will be (by chance) simulated for a badge that belongs to an employee that does indeed have server room access associated with their card, which then unlocks the door. Brute-forcing requires that first a badge is captured, and then it uses that captured badge as a starting point for future brute-forcing operations to gain access to doors that their current badge does not allow at that moment.

It is to be understood that the “Thor” device disclosed herein could be considered a long-range or multifunction RFID device, apparatus, equipment, or tool. This device could be considered a multi-use reader, simulator, writer, etc., as disclosed in various ways herein.

With respect to processes of the system, there are various innovative embodiments that are contemplated. As a non-limiting example, the herein disclosed system does not require typing code on a computer or android phone, does not require bulky hardware, and allows multiple commands at a time while evaluating the output and results of the command (then, issuing another command based on the condition of the output received.) Instead, the disclosed system is an automated process by piping the output from one command into the next, or more specifically, detailing when an error has occurred if the previous command was not successful for one reason or another. Furthermore, the disclosed system could execute specialized code that exists not only in apps that the system runs, but also in the custom circuit boards and firmware specially configured for “Thor” or “Passport”.

Because of this, the disclosed devices work seamlessly together. As a non-limiting example, the disclosed devices could allow the user to choose an action option from a mobile app in a way that is as simple as pressing a button (i.e. with no code), then subsequently a command is sent to an appropriate device. Device #1 could receive a command, execute desired actions, send back the state and output of a command to an app and user, and store the captured data and the status within the app. Subsequently, the app automatically sends the appropriate information and next command set to device #2. This all works in perfect unison between all devices in a way that is (or seems) autonomous and/or discreet.

In one example use scenario, capturing and cloning a proxmark card could include: starting a user's mobile session, and using Thor to automatically discover a card type. Once discovered, Thor is set to capture on a detected card type and begins capturing badges when in range. At this point, this information is relayed to a user in a user-friendly way via the mobile app. When a badge is captured and auto-clone or auto-simulate is enabled, it is captured by Thor, and sent to a mobile app for storage and user notification, automatically sent to Passport, and/or the process of writing or simulating is conducted. This disclosed seamless command and control of the three different devices and the hand-off or passthrough of information and data is one element (among many) that provides unique utility.

In one additional scenario, such as cracking a MiFare Classic card, the process could be generally considered the same as the scenario above, but while having additional steps and hand-offs. Additionally, the automation processes leverage the resulting output of one command to automatically create and formulate the next command, which then creates the next, all discreetly and autonomously, while handing or handling data between all three devices. As a non-limiting example, the user could simply see a status icon such as, “Detecting badge. Badge Detected: MiFARE Classic. Attempting to crack the encryption 1/3. Attempting to crack the encryption 2/3. Attempting to crack the encryption 3/3. Badge crack successful! Captured MiFARE badge. Simulating MiFARE badge of Passport.”

In some examples the user does not see the code that is being run (in most instances they do not need to). If there is an error, problem, or issue, the user receives more detail, suggestions on what to try differently, or becoming notified/alerted if a targeted badge is not vulnerable to cracking.

The hand-off and command and control of all devices via a centralized, easy to use, code-free (from a user perspective), and automated fashion.

In some embodiments the methods, tasks, processes, and/or operations described herein may be automatically effected, executed, actualized, and/or carried out by a computing system including a tangible computer-readable storage medium, also described herein as a storage machine, that holds machine-readable instructions executable by a logic machine (i.e. a processor or programmable control device) to effect, execute, actualize, carry out, provide, implement, perform, and/or enact the above described methods, processes, operations, and/or tasks. When such methods, operations, and/or processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that a certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

As a non-limiting example, the disclosure teaches action by a processor to execute a “determining step” that cannot be done mentally, for example by determining any of the disclosed data, informatic values, or states by automatically tracking other data, informatic values, or states. For example, the disclosed systems and methods may automatically determine a second (dependent) state or value by automatically tracking a first (independent) state or value, the second state automatically depending on the first state.

The disclosure includes the practical application of a processor (logic machine), and this practical application may include the receiving of an input through a graphical user interface (GUI) such as a user selection to execute one or more tasks or operations. Such a practical application may include the automatic operation of one or more data- or state-determining tasks in response to such a user selection or user input. The practical application as such may automatically execute any of the herein operations based on automatically determining any of the disclosed values, data, informatics, or states.

It is to be understood that the disclosed systems and methods provide a specific manner of automatically executing or actualizing the disclosed tasks, operations, or methods in a manner that is an improvement over known systems and solutions. In addition to being a practical application of machines, the disclosure includes an inventive concept that is not anticipated or obvious in view of known systems and methods.

Furthermore, the systems and methods disclosed herein are configured to solve technical problems in computing in the field of the disclosure as set forth in the background section, where the problems have attributes that hinder, limit, and/or prevent the features, aspects, or elements disclosed herein from being enabled and/or implemented. Therefore the disclosed technical solutions eliminate or alleviate these problems and positively contribute to the technical abilities of existing computing systems and methods.

As a non-limiting example of such a practical application, embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, micro4, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on one or more standalone computers, partly on one or more standalone computers, as a stand-alone software package, partly on one or more standalone computers and partly on one or more remote computers, partly on one or more standalone computers and partly on one or more distributed computing environments (such as a cloud environment), partly on one or more remote computers and partly on one or more distributed computing environments, entirely on one or more remote computers or servers, or entirely on one or more distributed computing environments. Standalone computers, remote computers, and distributed computing environments may be connected to each other through any type of network or combination of networks, including local area networks (LANs), wide area networks (WANs), through the Internet (for example using an Internet Service Provider), or the connection may be made to external computers. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to schematic flowchart illustrations and/or block diagrams of methods, apparatus (systems), functions, and computer program products according to embodiments of the invention. It will be understood that each block of the flowchart illustrations and/or block diagrams, and combinations of blocks in the flowchart illustrations and/or block diagrams or functions, can be implemented by computer readable program instructions. Functions, including policy functions, are groups of computer readable program instructions grouped together that can be invoked to complete one or more tasks.

These computer readable program instructions may be provided to one or more processors of one or more general purpose computers, special purpose computer, or other programmable data processing apparatus to produce a machine, such that the instructions, which execute via the processors of the one or more computers or other programmable data processing apparatus, create means for implementing the functions/acts specified in the flowchart and/or block diagram block or blocks. These computer readable program instructions may also be stored in one or more computer readable storage mediums that can direct one or more computers, programmable data processing apparatuses, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto one or more computers, other programmable data processing apparatus, or other devices to cause a series of operational steps to be performed on the one or more computers, other programmable apparatuses or other device to produce a computer implemented process, such that the instructions which execute on the computers, other programmable apparatus, or other devices implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A method of capturing, cloning, cracking, and brute-forcing RFID access badges, the method comprising:
a first device configured to identify and capture a first badge automatically, and identify and capture a subsequent badge automatically, the first device configured to automatically recognize badges in a vicinity;
using at least one computer processor or logic machine, sending badge information to at least one of a mobile app and a second device; and
wherein the second device is configured to immediately begin a simulation process of a successfully captured badge, wherein the simulation process grants access previously unavailable through the second device, and wherein the simulation process grants access identical to the access of a previously captured badge.
